(19) United States
(12) Patent Application Publication
(10) Pub. No.: US 2018/0213294 A1
(43) Pub. Date: Jul. 26, 2018

(54) RECOVERING FROM GAPS IN VIDEO TRANSMISSION FOR WEB BROWSER-BASED PLAYERS

(71) Applicant: Ramp Holdings, Inc., Boston, MA (US)

(72) Inventors: Raymond Lau, Charlestown, MA (US); R. Paul Johnson, Burlington, MA (US)

(21) Appl. No.: 15/412,185

(22) Filed: Jan. 23, 2017

(51) Int. Cl. H04N 21/61; H04L 29/08; H04L 29/06; H04N 21/845; H04N 21/44; H04N 21/439; H04N 21/858; H04N 21/854; G11B 27/036

(52) U.S. Cl. CPC H04N 21/6125; H04L 67/02; H04L 65/4076; H04N 21/845; G11B 27/036; H04N 21/4394; H04N 21/858; H04N 21/85406; H04N 21/44016; H04N 21/44008

(57) ABSTRACT

Methods and apparatus, including computer program products, for recovering from gaps in video transmission for Web browser-based players. A system includes a first server, the first server including a stream of video, the steam of video including sequential audio and video segments, and a receiver, the receiver recreating the sequential audio and video segments as received from the first server, including recovering one or more gaps in the sequential audio and video segments, and making the audio and video segments with recovered one or more gaps available to a media player.

### BACKGROUND OF THE INVENTION

The invention generally relates to video transmission, and more particularly to recovering from gaps in video transmission for Web browser-based players.

In general, multimedia on the web is sound, music, videos, movies, and animations. Multimedia comes in many different formats. It can be almost anything one can hear or see. Examples include images, music, sound, videos, records, films, animations, and so forth. Web pages often contain multimedia elements of different types and formats.

Early web browsers had support for text only, limited to a single font in a single color. Later came browsers with support for colors and fonts, and images. Audio, video, and animation have been handled differently by the major browsers. Different formats have been supported, and some formats require extra helper programs to work, such as plug-ins. In general, plug-ins are computer programs that extend the standard functionality of a web browser. Examples of well-known plug-ins are Java® applets and Flash®.

Increasingly, browser-based video players are switching to using HTML5 video technologies such as Media Source Extensions (MSE) to play video instead of using plugin technologies.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for recovering from gaps in video transmission for Web browser-based players.

In general, in one aspect, the invention features a system including a first server, the first server including a stream of video, the steam of video including sequential audio and video segments, and a receiver, the receiver recreating the sequential audio and video segments as received from the first server, including recovering one or more gaps in the sequential audio and video segments, and making the audio and video segments with recovered one or more gaps available to a media player.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram of an exemplary network.

FIG. 2 is a block diagram of an exemplary Dynamic Adaptive Streaming over HTTP (DASH) system.

FIG. 3 is a block diagram of exemplary gap filling.

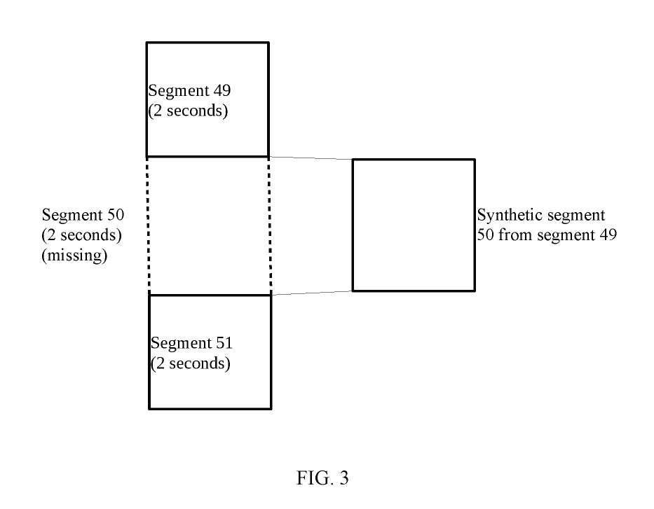

FIG. 4 is a block diagram of exemplary gap filling.

FIG. 5 is a block diagram of exemplary gap filling.

FIG. 6 is a block diagram of exemplary gap filling.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Though we will present the invention by example of a multicast transmission, the actual invention relates to gap recovery and would be equally applicable to other video transmission mechanisms that may result in gaps. We discuss one particular case, that of incorrect encoding later on. In the context of a unicast HTTP-based transmission, the “transmitter” might simply be an HTTP server. The “receiver” might also be built into a browser or into a media player. Finally, though we describe “segment” in the context of an HTTP pseudo streaming data object accessible at a particular URI (e.g. DASH m4s, HLS ts), we intend the interpretation of “segment” to encompass any grouping of encoded data suitable for decoding purposes. As it applies to video, the smallest “segment” is typically a set of frames that can be decoded without knowledge of frames outside that group—also known as a Group of Pictures (GOP). In our usage, a “segment” can also be any combination of other potential “segments.” As it applies to AAC-coded audio, a set of 1024 samples forming a block used for encoding/decoding is the smallest “segment.” As another example, within the DASH specification, there is also the concept of subsegments within a DASH segment. We consider both the DASH segment and the subsegments to be “segments” in the present invention.

In general, Media Source Extensions (MSE) are now a standard part of modern HTML5 web browsers. MSE is a W3C specification that enables JavaScript® code to send video and audio codec data directly to a browser for playback. There are no plug-ins to install or configure. The audio or video downloads and plays in a webpage. More specifically, MSE adds buffer-based source options to HTML5 media for streaming support. Previously, one had to download a complete video file to play (though progressive download can permit playback to begin during the download process), or use an add-on like Silverlight® or Adobe® Flash to stream media. With MSE, no client add-ons are required for streaming. Additionally, one can stream video from a standard HTTP server. A special media server is not required.

Media codec data in the form of media segments are added to a MSE sourceBuffer via an appendBuffer( ) call. Each media segment contains a continuous portion of the media timeline indicated by timestamps. The MSE specification refers to the byte stream format as the format of the media segments to be appended to a sourceBuffer. We refer to this herein as the “media codec data.” We also note that the “segments” added to the MSE buffer do not necessarily need to be the same as the “segments” that are defined in the context of particular HTTP pseudo-streaming protocols.

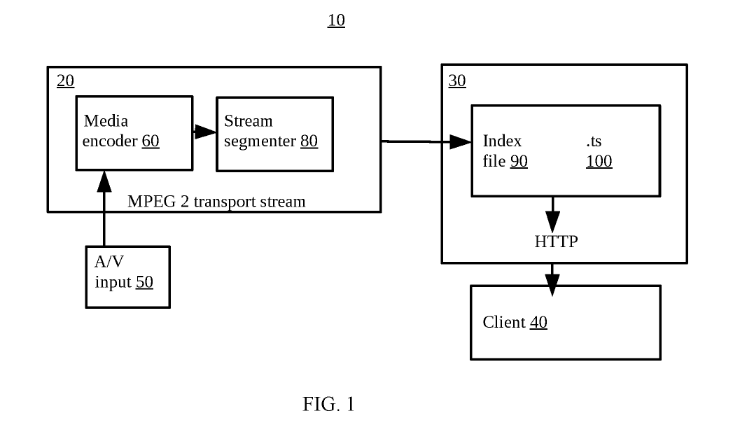

As shown in FIG. 1, an exemplary steaming network 10 includes a server component 20, a distribution component 30, and client software 40. The server component 20 is responsible for taking input streams of media 50 and encoding them digitally in a media encoder 60, encapsulating them in a format suitable for delivery, segmenting the encoded media stream in a stream segmenter 80 and preparing the encapsulated media for distribution.

The distribution component 30 includes web servers that are responsible for accepting client requests and delivering prepared media and associated resources to the client. For large scale distribution, edge networks or other content delivery networks may also be used.

The client software 40 is responsible for determining the appropriate media to request, downloading those resources, and then reassembling them so that the media can be presented to the user in a continuous stream.

In steaming network 10, media encoder 60 takes audio-video input and turns it into an MPEG-2 Transport Stream, which is then broken into a series of short media files by the software stream segmenter 80. These files are placed on the web server 30. The segmenter 80 also creates and maintains an index file 90 (also referred to as a manifest file) containing a list of the media files 100. A URL of the index file 90 is published on the web server 30. Client software reads the index 90, then requests the listed media files in order and attempts to display them without any pauses or gaps between segments.

In summary, with HTTP pseudo-streaming video formats (also known as segmented or chunked HTTP video), a media stream (or a set of media streams, e.g. video plus audio), is divided into small segments, typically of 2 to 10 seconds each. Each segment is delivered over HTTP. Examples include Dynamic Adaptive Streaming over HTTP (DASH, c.f. ISO/IEC 23009-1:2014(E)), HTTP Live Streaming (HLS, draft-pantos-http-live-streaming-20 at https://tools.ietforg/html/draft-pantos-http-live-streaming-20), HTTP Dynamic Streaming (HDS), SmoothStreaming®, and so forth. Actual segments may be raw media codec data, or may include additional encapsulation (such as informational headers, or an interleaving of video and audio codec data). HTTP can also be delivered over HTTPS, or over other protocols (such as FTP or even a file in the file system). As used herein, the term HTTP herein generically to mean any such means, without specific limitation to the actual HTTP protocol.

Associated with the segments is a manifest or index identifying the location of segments. This can be a list (as in HLS, or a SegmentList in DASH) or it can be a template for constructing location information for the segments (as in the case of a SegmentTemplate in DASH).

A typical HTML5 player determines the next segment to be played, loads it via HTTP, and extracts (if needed) and provides the raw media codec data to the MSE sourceBuffer. The MSE framework will place this segment onto the media timeline based on the timestamps contained within the media codec data.

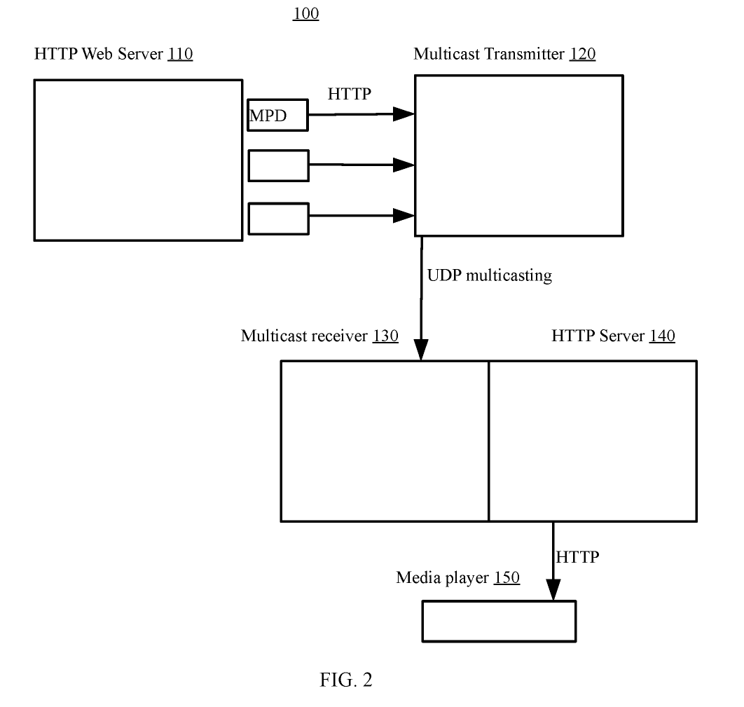

By way of one specific example, FIG. 2 illustrates a DASH system 100 includes HTTP server 110 that hosts DASH video, a multicast transmitter 120, a multicast receiver 130, a HTTP server 140 and a player 150. Video and audio hosted on the HTTP server 110 is segmented into video (.m4v) segments and audio (.m4a) segments. Also included is a MPD manifest. The MPEG-DASH Media Presentation Description (MPD) is an XML document containing information about media segments, their relationships and information necessary to choose between them, and other metadata that may be needed by clients. The segments and MPD are transmitted to the multicast transmitter 120.

The multicast transmitter 120 parses the MPD, determines when to retrieve the video and audio segments, retrieves them at the appropriate time, packages them into User Datagram Protocol (UDP) multicast along with the MPD and initial segments.

The multicast receiver 130 decodes the UDP multicast, recreates the MPD and initial segments, then video/audio segments as the are received. The MPD and segments are made available to the player 150 via the HTTP server 140.

It is typically expected that successive segments will compose successive portions of the media timeline, though the user seeking forwards or backwards will result in discontinuities. The typical behavior of browsers is to stop (in a more permanent and fatal sense than a slight pause) playback when reaching an unpopulated portion of the media timeline.

Because the HTTP protocol is used, the concept of an inaccessible portion of the media timeline is unusual, as in theory, any referenced segment (either explicitly via list or calculated via a template, or otherwise) can be loaded at any time over HTTP. Thus, many HTML5 video players do not handle well the case of inaccessible segments (what we will refer to as “gaps”) in the media timeline. However, when segmented video formats are used with another channel, such as a linear multicast channel, there may indeed be inaccessible portions of the media timeline. Also, encoding errors and the like can result in unavailable segments even in the more traditional, non-linear transmission case.

The HLS specification had always support for an EXT-X-DISCONTINUITY tag (C.f. ss. 4.3.2.3 in draft-pantos-http-live-streaming-20) to support gaps. Thus, older Flash®-based implementations of HLS players support gaps. However, as of November 2016, a survey of available HTML5 based HLS players show both supporting players and non-supporting players. A survey of the major HTML5-based DASH players shows no support for gaps in DASH. As mentioned previously, we refer to gaps as inaccessible segments in the media timeline. When there is a gap, the player will typically halt playback. It possible for players to take the approach of playing over a gap, that is, advancing the play head from the end of a populated timeline island to the start of the next populated timeline island, but this does not appear to be the case for several HLS players and for all DASH players surveyed in November 2016. This is most probably because player implementers expect that gaps will not exist as segments can be retrieved on-demand over HTTP.

While we focus primarily on HTML5 MSE technology with its current timeline limitations and behaviors, the techniques we discuss herein are easily generalizable to other media technologies with similar behavior.

The most common case when gaps cannot be easily filled in is when the stream is transmitted via a linear means, i.e., data are transferred on a timeline but without the ability to retrieve previously transferred data that may become lost in transmission. This occurs with systems that take a broadcasting approach to video, such as using UDP multicasting. These approaches are typically used to reach large audiences, where providing for retrieval to fill in the gaps may be too expensive in terms of traffic load.

Another possible cause of gaps is an encoding or packaging error at the source of the segmented HTTP video.

In such cases, absent a player providing support for gaps, a loss during the transmit/receive process will result in a gap which will cause playback to stop. It is possible for a layer of code above the player to “restart” the player, however, recovery times tend to be slow because most players require at least two or three segments before playback can start. Thus, the loss of one segment to transmission issues usually requires three to four segments of recovery time. Moreover, the visual presentation of restarting the player is typically undesirable.

The present invention specifically handles “filling the gaps” that work particularly well for HTML5 MSE-based players.

For example, even if a particular gap cannot be filled with correct data, it can be filled by other data, e.g., a filler video like a black screen. However, segmented protocols are moving in the direction of separating the initialization segment from the media segments. This is a fundamental aspect of MSE (c.f. ss. 3.5.7 of https://www.w3.org/TR/2016/PR-media-source-20161004/) that is mirrored by some, and increasingly more, segmented protocols, e.g., DASH.

With a separate initialization segment, each media segment is decoded by the media codec relative to pre-initialization by the initialization segment. Thus, to compose a filler, a receiving software or apparatus must reverse-engineer the initialization segment and then encode an appropriate filler segment. This is a very expensive process and requires bringing in almost a full media encoder as well as a full parser for the multiplexing layer (as the initialization segment can also include track ID mappings, etc.). This needs to be repeated for each codec and multiplex supported, making it impossible to design codec-neutral and multiplex-neutral transmission/receiving systems.

Another possible solution is to make the next segment take the place of the missing segment. This may work for some protocols and implementations, e.g. HLS specifically supports EXT-X-DISCONTINUITY tags, though some HTML5-based HLS players do not correctly handle them, so this would not work for such players. In DASH, when a SegmentTemplate is used, the calculation of the segment URI is timeline dependent. This requires performing URI translation, as well as rewriting timecodes, for all segments after the gap. Such a post-gap rewriting technique would be one possible approach.

When used with DASH ISO Base media file format live profile, post-gap rewriting would typically require:

1. aliasing future references from URIs constructed using $Number$ and $Time$ in the SegmentTemplate to account for the renumbering

2. adjusting earliest_presentation_time in the sidx box (if any). C.f. ss 8.16.3 of ISO/IEC 14496-12:2008/FDAM 3:2011(E)

3. adjusting baseMediaDecodeTime in the tfdt box C.f. ss.8.8.12 of ISO/IEC 14496-12:2008/FDAM 3:2011(E)

4. adjusting sequence_number in the mfhd box. C.f. ss. 8.33 in ISO/IEC 14496-12:2005(E).

There may be other adjustments required depending on the particular packager and player, but we have found this basic set to work in most environments.

In general, with post-gap rewriting or any of the later techniques, such adjustments should end when reaching the end of a Period.

Analogous updates may be required for other segmented protocols. For example, for HLS, if the player does not handle EXT-X-DISCONTINUITY properly, then:

1. URI construction can be adjusted either by aliasing or by changing the media playlist

2. adjust the PCR codes in the transport stream C.f. ss 2.4.3.4 in ISO/IEC 13818-1:2000(E)

3. adjust presentation timestamp (PTS) and decoding timestamp (DTS) when present in the PES packets C.f. ss 2.4.3.7 C.f. ss 2.4.3.4 in ISO/IEC 13818-1:2000(E)

The methods of the present invention, described fully below, take a different direction with several benefits, including simpler implementation and a potential to avoid any buffering to be seen by the viewer.

The description of our system for filling in the gaps is described in terms of DASH video, however, the same concepts can be applied to all present (and likely most or all future) segmented video protocols.

For the purposes of this description, we will assume the segment size is two (2) seconds and that we have one video and one audio track, packaged into separate streams. Further, we will assume that the segments are numbered starting from 1 (1, 2, 3, 4, etc.) and that the missing segment is segment 50. Segment 50 constitutes the entirety of the one and only gap in this example.

One key observation is that all media segments are already encoded to match the initialization segment. Thus, our first idea is to repeat a previously received media segment to fill in the gaps. As a matter of fact, if we repeat the media segment immediately preceding the gap, the visual disruption is minimized due to the high degree of visual similarity. Thus, in the following discussion, we will use segment 49 as the pre-gap segment, however, any available pre-gap segment can be used.

We will also assume a linear unidirectional transmission mechanism between the transmitter and receiver, such as a unidirectional multicast transmission. Thus, if due to network data loss, segment 50 is not successfully received by the receiver, there is no way to retrieve it (e.g., no way to request a retransmission).

FIG. 2 illustrates a transmitter taking a DASH video source and encapsulating it into a linear unidirectional multicast one segment at a time. The multicast is received by a receiver, which caches the received segments, and reassembles a DASH format presentation for access by a player running in a browser. Periodically (perhaps as frequently as every segment), the initialization segments are also transmitted to enable a receiver to join the linear multicast at any time. Segment 50 is lost in transmission and never arrives at the receiver.

In our system, assuming the simple case where all segments are of equal size, the simplest solution is to replicate segment 49 when segment 51 is received. Once segment 51 is received, it becomes known to the receiver that segment 50 did not arrive. The receiver, having already received segment 49, can duplicate it to become segment 50.

For the DASH protocol specifically, and using the ISO Base media file format live profile—i.e. urn:mpeg:dash:profile:isoff-live:2011) the duplication also requires several adjustments to the boxes within the segment. Important adjustments include:

1. earliest_presentation_time in the sidx box (if any). C.f. ss 8.16.3 of ISO/IEC 14496-12:2008/FDAM 3:2011(E).

2. baseMediaDecodeTime in the tfdt box C.f. ss.8.8.12 of ISO/IEC 14496-12:2008/FDAM 3:2011(E).

3. sequence_number in the mfhd box. C.f. ss. 8.33 in ISO/IEC 14496-12:2005(E).

The adjusted segment will now look like a proper segment 50 to the player, though it contains the raw codec data from segment 49. Note that for typical videos today, the above set of exemplary adjustments are sufficient, but this enumeration (and other enumerations described herein) is (are) not intended to be exhaustive of all needed adjustments for all possible cases, especially as protocols are revised in the future.

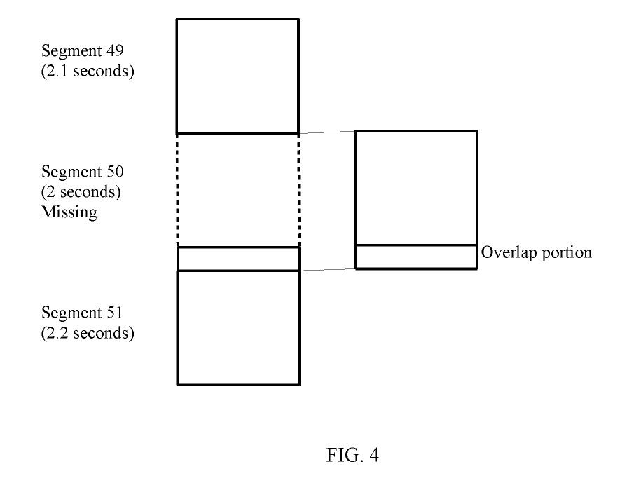

As shown in FIG. 4, unfortunately, in most cases, not all segments will be exactly the same duration. There are two primary reasons for a possible mismatch.

One major reason is that segments typically begin on key frame boundaries. This is required for the ISO Base media file format live profile and is known as starting with an SAP (stream access point) in the DASH specification. This is so that random seeking can commence playback at segment boundaries. Not all encoding systems will insert key frames at precise periods—for example, a slow encoder may be late in inserting a key frame after compressing a particularly challenging portion of fast action video due to the inability to computationally keep up.

The other major reason is that for the audio stream, the AAC codec is typically used. AAC processes audio 1024 samples at a time, thus, the SAP for the audio stream has to be on a 1024 sample boundary. This typically will not line up perfectly with the video segment size. Thus, most packagers will have slightly more audio corresponding to a video segment in some cases, and slightly less in other cases, so that the average segment size of audio and video remain in sync. Many other audio codecs have a similar requirement.

The case where segment 49 is longer (either in terms of audio or video or both) than the lost segment 50 is actually quite simple. We observe that players will typically write into the MSE source buffer each segment as it is received. In the way MSE operates, the last write into a portion of the media timeline wins—that is, it will overwrite any earlier writes. Because the synthetic segment 50 is being presented to the player after segment 51 is available, segment 51 is de facto available to the player at the same time as segment 50. So the browser places segment 50 (synthetic) into the source buffer and then almost immediately afterwards, places segment 51 into the source buffer. Segment sizes in actual use are greater than or equal to 1 second in duration. Thus, by the time the browser implementation of MSE gets to the point (in terms of video playback) in the timeline where segment 50 overlaps segment 51, it is in practice assured that segment 51 will have already been written into the source buffer, winning out against the overlap from synthetic segment 50.

As shown in FIG. 4, in the case where segment 49 is shorter than the lost segment 50 is somewhat more complex. In our system, our approach is to form our synthetic segment 50 by concatenating enough copies of segment 49 to reach a segment size greater than or equal to the lost segment 50.

Again, taking the example of the ISO Base media file format live profile in DASH, this concatenation involves at least the following adjustments:

1. all of the previously mentioned adjustments for the equal size case

2. in the sidx box (if any), duplicate the set of subsegment information (reference_type, reference_size, subsegment_duration, starts_with_SAP, SAP_type, SAP_delta_time). C.f. ss 8.16.3 of ISO/IEC 14496-12:2008/FDAM 3:2011(E). In the event of a single subsegment, it is also possible to simply extend the subsegment_duration.

4. concatenate the entries in the trun box C.f. ss. 8.7.13 in ISO/IEC 14496-12:2005(E).

5. concatenate the raw codec data in the mdat box

3. in general, have only one copy of most boxes

4. various offset pointers and lengths need correction after these operations as these operations will change the length of the altered boxes

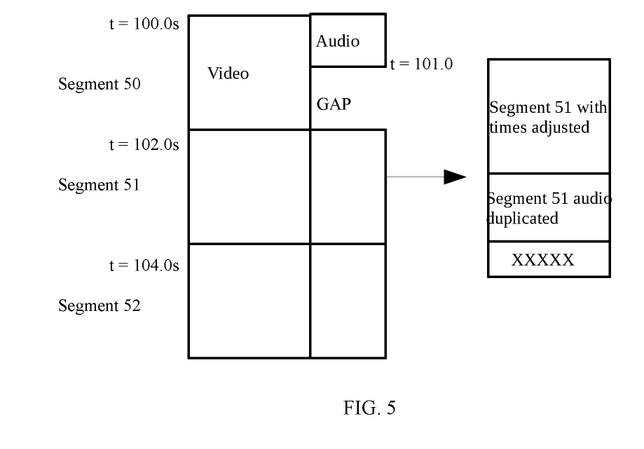

As shown stating in FIG. 5, next, we turn our attention to errors at the source of the segmented video. In this case, say segment 50 had an incorrect audio track. Say the video track covers time 100.0 to 102.0 seconds, and the audio track covers time 100.0 to 101.0 seconds. The post-gap segment, 51, has a video track covering time 102.0 to 104.0 seconds with an audio track from 102.0 to 104.0 seconds.

In this improperly segmented video stream case, the gap from 101.0 to 102.0 seconds in the audio track would cause the player to fail. To fill this gap, we instead modify the successor segment 51 by doubling (or tripling, etc. as needed to fill the size of the gap) it and adjust the start time of the concatenated segment to 101.0 seconds, the start of the gap. This will cause a momentary playback repeat at time 103.0 seconds, but that is much preferable to a player failure. Note that as the gap only exists in the audio track, we can optimize by only concatenating the audio track. This is particularly easy when the tracks are delivered in a non-multiplexed manner, as is typically the case with the DASH ISO Base media format live profile. Alternatively, instead of taking audio from the successor segment 51, we can also take audio from segment 50 (the predecessor to the gap) to fill the audio gap in an analogous manner.

It is also possible to use similar techniques to address variants such as when the video track results in a gap or when both audio and video tracks result in a gap.

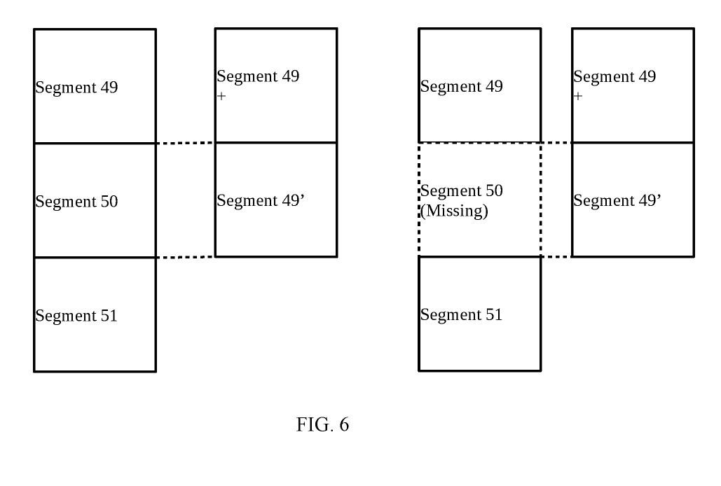

As shown in FIG. 6 and FIG. 7, prophylactic segment expansion is yet another possibility. As each segment is received, the receiver can always concatenate the segment with itself to make it a longer segment. We might do this twice to anticipate a 1 segment gap or 3 times to anticipate up to a 2 segment gap, etc. (one extra time to account for possible segment size mismatch). If there turns out to be no gap, then the successor segment will overwrite the prophylactic expansion in the timeline. But if there turns out to be a gap, playback in the player will not be interrupted (i.e., will not see a “buffering” indication), though the viewer will of course see the synthetically duplicated segment instead of the correct video in the gap.

The primary cost of prophylactic segment expansion is the extra data sent by the receiver to the media player. However, in many use cases, the receiver is running on the same computer as the media player, thus, the added bandwidth is an in-memory transfer cost as opposed to a network bandwidth cost. The primary added advantage of prophylactic segment expansion is to avoid giving a “buffering” indication to the viewer.

Note that the prophylactic segment expansion can address both the lost segment problem as well as the errors at the source problem.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system comprising:
a first server, the first server comprising a stream of video, the stream of video comprising a plurality of sequential audio and video standard segments; and
a receiver, the receiver recreating the sequential audio and video standard segments as received from the first server, said receiver identifying unplayable received segments in said received video and audio segments, and inserting, in the place of each said unplayable received segment, a playable segment recovered from received playable standard segments of said received video/audio stream,
said inserting playable segments including recovering one or more gaps in the received sequential audio and video standard segments, and making the audio and video standard segments with recovered one or more gaps available to a media player.

2. The system of claim 1 wherein the sequential audio and video segments are in an HTTP pseudo-streaming protocol format where one or more initialization segments are used.

3. The system of claim 1 where multicast is used for the transmission.

4. The system of claim 1 wherein the media player includes Media Source Extensions (MSE).

5. The system of claim 1 wherein recovering the one or more gaps comprises:
identifying a first segment just prior to a gap;
cloning the first segment into a synthetic second segment; and
inserting the cloned first segment as the recovered segment in the audio and video segments subsequent to the first segment.

6. The system of claim 5 wherein the cloning comprises:
making adjustments in order to look like a proper segment follows the first segment.

7. The system of claim 1 wherein a first segment is of a first duration, a gap is of a second duration and a third segment is of a third duration.

8. The system of claim 7 wherein recovering from the one or more gaps comprises:
cloning the first segment into a synthetic second segment; and
inserting the cloned first segment as the recovered segment in the audio and video segments subsequent to the first segment.

9. The system of claim 8 wherein the media player receives the audio and video segments with the recovered segment, loads the segments onto a Media Source Extensions (MSE) buffer timeline in order, an overlapping portion of the third segment overwriting a portion of the recovered segment.

10. The system of claim 1 wherein the audio and video segments received are improperly segmented.

11. The system of claim 10 wherein recovering from the one or more gaps comprises:
loading a segment prior to a gap;
loading a segment subsequent to the gap;
modifying the subsequent segment; and
adjusting a start time of the modified segment to a start time of the gap, causing a momentary playback repeat.

12. The system of claim 10 wherein recovering from the one or more gaps comprises:
loading a segment prior to a gap segment;
modifying the prior segment;
adjusting a start time of the modified segment to a start time of the gap segment; and
loading a segment subsequent to the modified gap segment.

13. The system of claim 1 wherein recovering from the one or more gaps comprises:
loading a first segment;
concatenating the first segment with itself to fill a gap; and
overwriting the concatenated segment with an actual received segment if the media player determines there is no gap.

14. A non-transitory computer readable medium comprising instructions to be executed by a processor-based device, wherein the instructions, when executed by the processor-based device, perform operations, the operations comprising:
sending a stream of video from a first server to a receiver, the stream of video comprising a plurality of sequential audio and video standard segments, the receiver identifying unplayable received segments in said video and audio segments, and inserting, in the place of each said unplayable received segment, a playable segment recovered from received playable standard segments of said received video/audio stream,
said inserting playable segments in the sequential audio and video segments as received, includes recovering any gaps in the received sequential audio and video standard segments, and making the received audio and video standard segments with recovered gaps available to a media player.

15. The medium of claim 14 wherein the sequential audio and video segments are in an HTTP pseudo-streaming protocol format where one or more initialization segments are used.

16. The medium of claim 14 where multicast is used for the transmission.

17. The medium of claim 14 wherein the media player includes Media Source Extensions (MSE).

18. The medium of claim 14 wherein recovering the one or more gaps comprises:
identifying a first segment just prior to a gap;
cloning the first segment into a synthetic second segment; and
inserting the cloned first segment as the recovered segment in the audio and video segments subsequent to the first segment.

19. The medium of claim 18 wherein the cloning comprises:
making adjustments in order to look like a proper segment follows the first segment.

20. The medium of claim 14 wherein a first segment is of a first duration, a gap is of a second duration and a third segment is of a third duration.

21. The medium of claim 20 wherein recovering from the one or more gaps comprises:
cloning the first segment into a synthetic second segment; and
inserting the cloned first segment as the recovered segment in the audio and video segments subsequent to the first segment.

22. The medium of claim 21 wherein the media player receives the audio and video segments with the recovered segment, loads the segments onto a Media Source Extensions (MSE) buffer timeline in order, an overlapping portion of the third segment overwriting a portion of the recovered segment.

23. The medium of claim 14 wherein the audio and video segments received are improperly segmented.

24. The medium of claim 23 wherein recovering from the one or more gaps comprises:
loading a segment prior to a gap;
loading a segment subsequent to the gap;
modifying the subsequent segment; and
adjusting a start time of the modified segment to a start time of the gap, causing a momentary playback repeat.

25. The medium of claim 23 wherein recovering from the one or more gaps comprises:
loading a segment prior to a gap segment;
modifying the prior segment;
adjusting a start time of the modified segment to a start time of the gap segment; and
loading a segment subsequent to the modified gap segment.

26. The medium of claim 14 wherein recovering from the one or more gaps comprises:
loading a first segment;
concatenating the first segment with itself to fill a gap; and
overwriting the concatenated segment with an actual received segment if the media player determines there is no gap.
